(19) United States
(12) Patent Application Publication
(10) Pub. No.: US 2007/0051206 A1
(43) Pub. Date: Mar. 8, 2007

(54) Hammer and support hook

(76) Inventor: Jeffery A. Horton, Fremont, NH (US)

Correspondence Address: DAVIS & BUJOLD, P.L.L.C., 112 PLEASANT STREET, CONCORD, NH, 03301, US

(21) Appl. No.: 11/220,149

(22) Filed: Sep. 6, 2005

(51) Int. Cl. B25D 1/00

(52) U.S. Cl. 81/20

(57) ABSTRACT

A clip or hook affixed to a tool, in particular a hook affixed directly to a hammer for supporting the hammer in a desired location or position such as on a belt loop, a waist band or a lip of a pocket of the users clothing. The hook or clip is affixed to the hammer in a specific position and orientation which does not interfere with the ordinary use of the hammer, permits placement and retention of the hammer within easy reach of the user, and facilitates acquisition of the hammer when needed by the user.

### FIELD OF THE INVENTION

This invention relates to a clip or hook affixed to a tool, in particular a hook affixed directly to a hammer for supporting the hammer in a desired location or position such as on a belt loop, a waist band or a lip of a pocket of the users clothing. The hook or clip is affixed to the hammer in a specific position and orientation which does not interfere with the ordinary use of the hammer, permits placement and retention of the hammer within easy reach of the user, and facilitates acquisition of the hammer when needed by the user.

### BACKGROUND OF THE INVENTION

Hammers are one of the most useful and common tools in the construction industry and have been known for hundreds, if not thousands, of years for assisting the user in, striking, breaking, moving or otherwise affecting a change in position or entropy to another object. A hammer may have many forms but in general comprises a longitudinal handle which can be held by either one hand or two of the user, and one end of the handle is provided with a head having at least a striking surface for striking another object formed substantially perpendicularly to the handle.

In most cases, a user, who may be a professional carpenter, tradesman, homeowner, or most anybody who has need of a hammer, utilizes the hammer to drive nails in order to secure two pieces of material such as wood to one another, for instance framing a house, roofing or siding a house.

It is also well known in the art that carpenters often use a construction tool belt which includes, among other things, a metal loop for supporting the hammer when not in use. The metal loop is generally secured to a heavy piece of leather or cloth on the tool belt which maintains the loop in a substantially horizontal plane relative to the ground adjacent the user's waist. The loop is sized to easily receive the free end of the handle of the hammer being substantially stowed vertically inserted through the loop. The length of the head of the hammer is greater than the diameter of the metal loop and thus the head comes to rest on a top edge of the metal loop thereby supporting the hammer in the metal loop.

There are many instances where a user does not desire to wear a belt, or cannot wear a tool belt for safety reasons or even comfort or because of potential damage to the structure or materials with which they are working. In addition, these tool belts and metal loops are bulky and may have numerous extraneous items attached to them which the user does not desire to carry around.

Additionally, to extract a hammer or similar tool from such a tool belt or metal loop where the head of the hammer is resting on the top edge of the loop, the user must grasp the head of the hammer, which is generally not intended to be grasped, and pull upwards withdrawing the handle from within the loop. As can be appreciated, once extracted from the loop, the user is still holding the head of the hammer with one hand, and thus cannot use the hammer without either shifting hands and placing the opposing hand around the handle or dropping, tossing, or otherwise putting down and arranging the hammer in order to properly grasp it by the handle.

### SUMMARY OF THE INVENTION

It is an object of the present invention to provide a tool, in particular a hammer, having a hook or clip for facilitating support of the tool on a users waist band, belt loop or pocket lip.

It is a still further object of the present invention to provide the hook or clip which is unobtrusively attached to the handle of the hammer so as not to effect the swing weight or balance of the hammer.

It is yet a still further object of the present invention to provide a clip or hook affixed to the hammer which does not interfere with the use and operation of the head of the hammer and use of the mandrel or fork.

It is yet another object of the present invention to provide an integral support system for a tool which does not require any particular extraneous loop or fastener or other accouterment which must be worn by the user separately from the tool.

It is still yet another object of the present invention to provide a clip or hook which facilitates the support of the tool or hammer on the clothing or nearby equipment to a user which permits the user to immediately grasp only the handle for placing the tool into operation.

A hammer comprising a head comprising a strike face, a claw and a receiving aperture, a handle having a first end for being received in the receiving aperture of the head and a free end and a hook affixed to the handle between the first end and the free end wherein the hook is defined by a substantially unshaped member having a first leg affixed directly to the handle and a second leg contiguous with and depending from the first leg.

### BRIEF DESCRIPTION OF THE DRAWINGS

FIG. 1 is a figure of a prior art hammer having a contiguous handle and head;

FIG. 2 is a planar view of a prior art hammer having a separate head and handle;

FIG. 3 is a perspective view of a hammer having a hook according to an embodiment of the present invention;

FIG. 4 is a side planar view of a hammer having the hook according to an embodiment of the present invention; and

FIGS. 5 and 6 are front an rear views respectively of a hammer having the hook according to an embodiment of the present invention; and

FIG. 7 is another embodiment of the hammer with a hook at the free end.

### DETAILED DESCRIPTION OF THE PREFERRED EMBODIMENTS

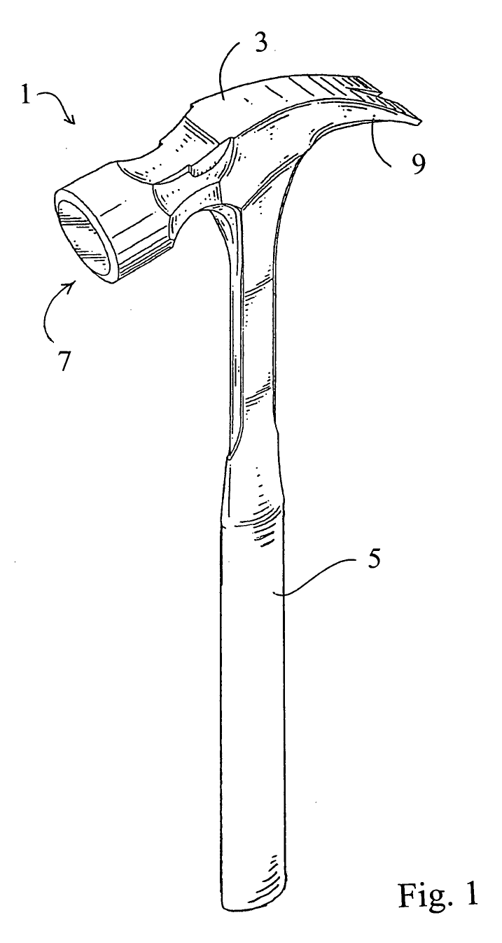

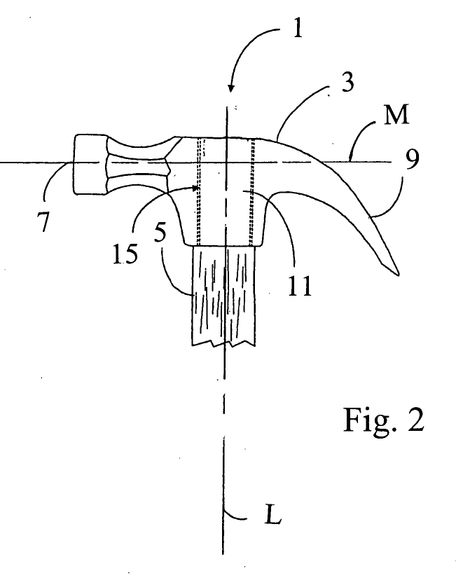

It is well known in the art, as seen in FIGS. 1 and 2, that a hammer 1 is comprised of a head 3 and a handle 5. The head 3 and handle 5 may be integrally formed from a single piece of steel for instance as seen in FIG. 1, or the head 3 and handle 5 joined in a two part form as is more common and as shown in FIG. 2. The handle 5 may be made of any number of different materials including plastic, fiberglass, rubber, wood, metal, carbon fiber, etc. and be attached to the steel head 3 by different known arrangements and methods.

In the more common two part form the head 3 of the hammer 1 is of course made of steel generally having an oppositely disposed strike (striking) face 7 and a claw 9 arranged along a main axis M, and a receiving cavity or throughbore 15 defining a longitudinal axis L substantially perpendicular to the main axis M of the head 3 is formed in the head 3 between the striking face 7 and claw 9. A specifically designed first end 11 of the handle 5 fits snugly and securely within the throughbore 15 of the head 3 is inserted into the throughbore 15 along the longitudinal axis L which thus aligns the handle 5 generally perpendicularly to the main axis M of the hammer head 3. The first end 11 of the handle 5 may be glued, press fit or substantially permanently affixed within the cavity or throughbore 15 such that during use of the hammer 1, even during extreme conditions, the head 3 will not become loose nor separate from the handle 5.

It is also known to form a hammer 1 out of a single piece of steel such that there is little chance of the head 3 breaking away from the handle 5. In such a case, as seen in FIG. 1, the handle 5 extends from a substantially perpendicular integral connection to the head 3, strike (striking) 7 face and claw 9 to a free end 13 of the handle 5.

The handle 5 may also be made of a number of different materials and have different shapes, including, for example, an intermediate grippable rubber portion to facilitate ergonomic handling and comfort and a neck portion which is intermediate to the grippable handle 5 and extends between to the first end 11 to form the attachment end within the hammer head 3. In general, the handle 5, and especially the intermediate portion 17, should be fairly light in order to not effect the appropriate balance and swing weight of the hammer 1 which is set according to the weight of the steel hammer head 3 relative to the handle 5.

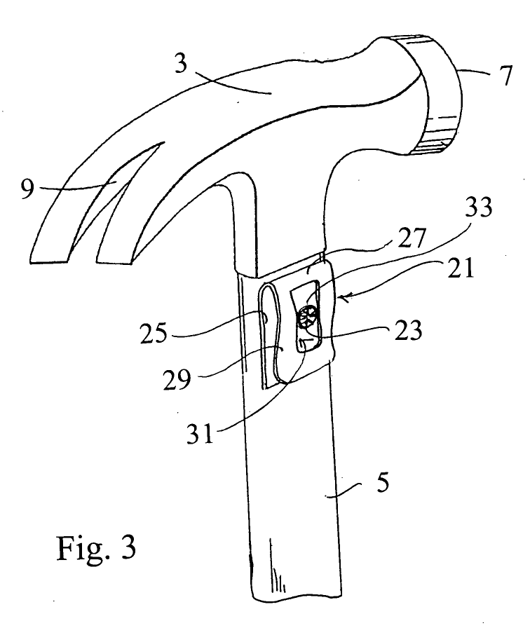

As seen in FIG. 3, a clip or hook 21 is affixed to the handle 5 generally in the region adjacent the intersection of the head 3 and the handle 5. The hook 21 may be fastened or affixed to the handle 5 by either removable or permanent means. Removable means being such items as a screw 23, bolt or other similar type fastening devices which affix items together somewhat less than permanently. Permanent means relates in general to welding, riviting, molding, casting or otherwise affixing or forming the hook 21 to the handle 5 by means which must be materially broken in order to remove the hook 21.

It is to be appreciated that the hook 21 is affixed to the handle 5 in such a manner and position that in the stowed position, the hammer 1 hangs right-side up, in other words, when the hook 21 is positioned for example to hang the hammer 1 on a waist band of the user, the head 3 is generally maintained vertically above the handle 5. It is also possible to affix or form the hook 21 integral with the head 3 of the hammer 1 and achieve the same stowable positioning. It is also quite possible to attach the hook 21 along the handle 5 closer to the free end 13 of the handle 5 and arranged in such a manner that the hammer 1 will hang upside down, i.e. with the handle 5 aligned vertically above the hammer head 3 dangling below the handle 5.

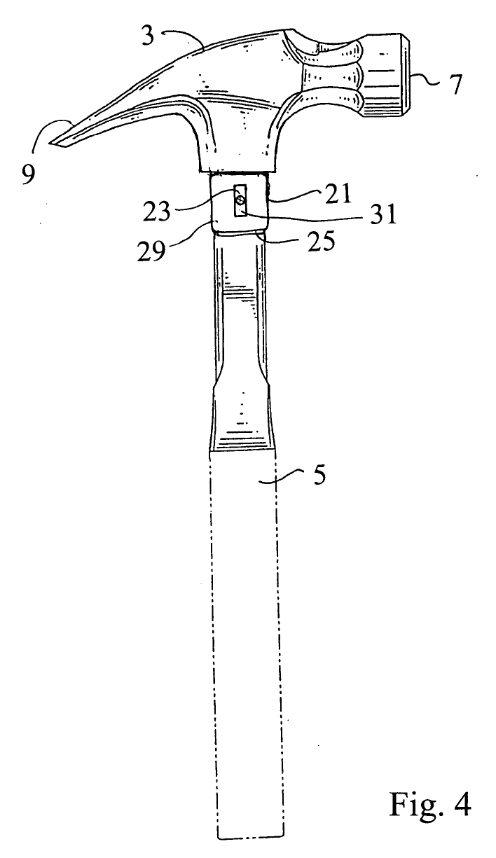

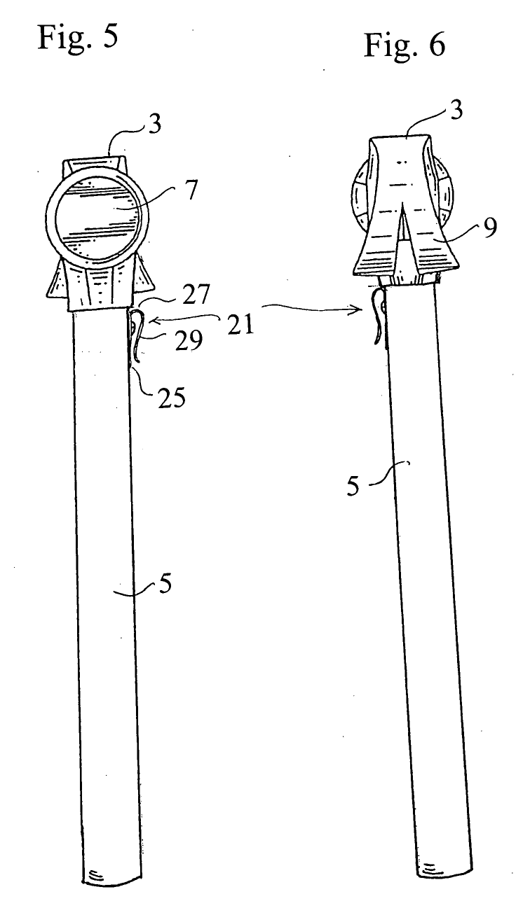

Turning to FIGS. 4, 5 and 6, the hook 21 is a substantially u-shaped device comprising an first leg 25 which is directly affixed to the hammer 1 in this case via a screw 23. For purposes of this description the hook 21 is shown generally attached at a point on the handle 5 adjacent the intersection of the handle 5 with the hammer head 3 so as to not interfere with operation of the hammer head 3, nor effect the weight or balance of the hammer head 3.

The u-shaped clip or hook 21 comprises the first leg 25 which is directly fastened to the handle 5 and extends substantially parallel with the handle 5 to a point of curvature 27 where it bends approximately 180° to form a second leg 29 depending downwards. The second leg 29 depends downwards in this embodiment being substantially parallel to the first leg 25 and spaced a distance therefrom to a second end which may flare slightly outwards as shown in FIG. 3 so as to be easily engageable, or catchable upon a desired edge, for example a user's waist band or pocket lip.

Where a screw 23 is utilized to affix the hook 21 to the handle 5 of the hammer 1, the first leg 25 is provided with a screw hole 33 sized for receiving the fastening device, which is inserted partially therethrough and then screwed into the intermediate portion 17 of the handle 5 of the hammer 1 to affix the hook 21 thereto. To facilitate access to the screw hole 33 and affixing the same to the handle 5, the second leg 29 of the hook 21 comprises an opening 31 which is large enough to provide access for instance for a screw driver to pass partially through the opening 31 in the second leg 29 and engage the screw 23 and facilitate either affixing or removing the hook 21.

Thus, it is to be appreciated, that a user may affix or remove such a clip or hook 21 by screwing or unscrewing, for example, a screw fastener through the first leg 25 of the hook 21 to the hammer handle 5. It is to be appreciated that the lengths of the first and second legs may be longer or shorter with respect to one another depending on certain design considerations, or the first and second legs may not be parallel but space at an acute angle so as to facilitate engaging different objects.

The first leg 25 may be fastened securely to the handle 5, i.e., so that it does not move relative to the handle 5 by the fastening device. For instance with a metal handle 5 the first leg 25 may be welded to the handle 5, or cast integrally therewith as well. The first leg 25 of the hook 21 may also be affixed so as to provide some amount of relative rotation between the hook 21 and the handle 5. This may facilitate the hammer 1 turning relative to the hook 21 in certain situations where the hammer 1 is in the stowed position and may hit against another object, or the floor. The turning or rotation of the hammer 1 relative to the hook 21 in such a situation provides some flexibility in the device to keep the hook 21 from being dislodged from the user's waist band or pocket lip etc., and the hammer 1 falling to the floor.

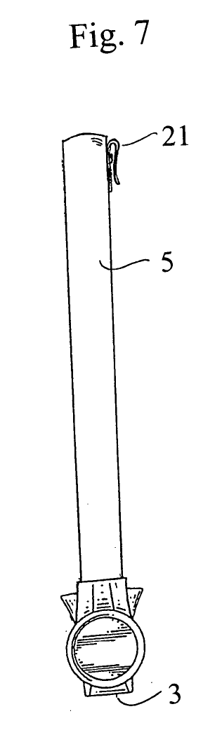

In a further embodiment of the present invention, the hook 21 could be oriented in the opposite direction, i.e. with the first and second legs extends towards the hammer head 3 and the bend or curvature 27 turned towards the free end 13 of the handle 5. In this embodiment the generally heavier weight of the hammer head 3 will help in maintaining the hammer 1 in the stowed position. In this manner it is possible to locate the hook 21 in a different location along the longitudinal length of the hammer handle 5, for instance closer to, or adjacent the free end 13 of the handle 5 so that the heavier hammer head 3 hangs downward when in the stowed position as seen in FIG. 7.

It is also to be appreciated that the clip or hook 21 may be removably fastened by a strap, a screw 23 or similar removable fastening device to the handle 5 so that it may be moved or rotated with respect thereto. It is also to be appreciated that a second fastening point could be used to provide a more secure attachment of the hook 21 to the hammer 1. For example a second screw 23 or similar fastening device could affix the first leg 25 to the handle 5 or head 3. A tab or detent or similar feature may also be formed on the first leg 25 of the hook 21 in order to engage a divot or slot formed in the handle 5 or head 3 so as to maintain the clip or hook 21 in a specific relative position with the handle 5.

Since certain changes may be made in the above described embodiments, without departing from the spirit and scope of the invention herein involved, it is intended that all of the subject matter of the above description or shown in the accompanying drawings shall be interpreted merely as examples illustrating the inventive concept herein and shall not be construed as limiting the invention.

I/we claim:

1. A hammer comprising:
a head comprising
a strike face;
a claw and a receiving aperture;
a handle having a first end for being received in the receiving aperture of the head and a free end; and
a hook affixed to the handle between the first end and the free end wherein the hook is defined by a substantially u-shaped member having a first leg affixed directly to the handle and a second leg contiguous with and depending from the first leg.

2. The hammer as set forth is claim 1 wherein the second leg of the u-shaped member is bent to be aligned substantially parallel with the first leg.

3. The hammer as set forth in claim 2 wherein the second leg of the u-shaped member is provided with an access port therethrough.

4. The hammer as set forth in claim 3 wherein the first leg of the u-shaped member is provided with an screw hole for receiving a screw to affix the hook directly to the handle.

5. The hammer as set forth in claim 4 wherein the u-shaped member is affixed to the handle near the first end of the handle adjacent a connection between the handle and the head of the hammer.

6. The hammer as set forth in claim 4 wherein the u-shaped member is affixed to the handle adjacent the free end of the handle.

7. The hammer as set forth in claim 1 wherein the hook defined by the u-shaped member further comprises an open end for receiving a supporting object upon which the hammer is to be stowed and the open end is aligned to face the free end of the handle.

8. The hammer as set forth in claim 1 wherein the hook defined by the u-shaped member further comprises an open end for receiving a supporting object upon which the hammer is to be stowed and the open end is aligned to face the first end of the handle.

9. A hammer comprising:
a head comprising
a strike face;
a claw and a receiving aperture;
a handle having a first end for being received in the receiving aperture of the head and a free end; and
a hook affixed to one of the head and the handle wherein the hook is defined by a substantially u-shaped member having a first leg affixed directly to the handle and a second leg contiguous with and depending from the first leg.

10. A method of stowing a hammer comprising the steps of:
forming the hammer with a head comprising a strike face; a claw and a receiving aperture;
attaching the head to a handle having a first end for being received in the receiving aperture of the head and a free end;
affixing a hook to the handle between the first end and the free end wherein the hook is defined by a substantially u-shaped member having a first leg affixed directly to the handle and a second leg contiguous with and depending from the first leg, and applying the hook to a desired object to secure the hammer thereto.
